(19) United States
(12) Patent Application Publication
(10) Pub. No.: US 2023/0229868 A1
(43) Pub. Date: Jul. 20, 2023

(54) ENQUIRY CHAT BOT AND ARTIFICIAL INTELLIGENT GUIDANCE SYSTEM AND ITS WORKING METHOD

(71) Applicants: Ali Alqahtani, Najran (SA); Surbhi Khan, Al Hasa (SA); Jarallah Alqahtani, Najran (SA); Ibrahim Alsaduni, Al-Majmaah (SA); Abdulmajeed Alqhatani, Najran (SA); Raed Alsini, Jeddah (SA); Arwa Mashat, Rabigh (SA)

(72) Inventors: Ali Alqahtani, Najran (SA); Surbhi Khan, Al Hasa (SA); Jarallah Alqahtani, Najran (SA); Ibrahim Alsaduni, Al-Majmaah (SA); Abdulmajeed Alqhatani, Najran (SA); Raed Alsini, Jeddah (SA); Arwa Mashat, Rabigh (SA)

(21) Appl. No.: 18/175,764

(22) Filed: Feb. 28, 2023

(51) Int. Cl. G06F 40/40; G06F 40/205; G06F 40/289; H04L 51/02

(52) U.S. Cl. CPC G06F 40/40; G06F 40/205; G06F 40/289; H04L 51/02

(57) ABSTRACT

The present invention generally relates to an enquiry chat bot and artificial intelligent guidance system comprises a receiving connector for receiving one or both of a voice message and an instant message from a client through a user computing device; an informing voice connector for switching discourse over completely to message; a normal language parser for separating the words into characterized watchwords; a conversational machine learning motor for attempting to bring the right exchange as indicated by the divided catchphrases that lead to the right expectation; and a ChatBot for breaking down the client's solicitation to find the purposes and concentrate the elements.

### FIELD OF THE INVENTION

The present disclosure relates to an enquiry chat bot and artificial intelligent guidance system and its working method. In more detail, the system is used to investigate and expound on the execution of a clever framework that is uphold telemedicine administrations utilizing normal language handling (NLP) system.

### BACKGROUND OF THE INVENTION

There is a requirement for change of the strategies that the medical care framework is utilizing to collaborate with patients on numerous levels.

From: (i) how patient's delicate information is safely put away and analysed, (ii) how the patient connects with the medical care framework to find solutions to his/her questions, (iii) how the patient recovers his/her conclusion in light of the gave side effects utilizing human language viable interfaces, (iv) how the patient books an arrangement utilizing human-like discussion.

The Wellbeing Bot has been created to close this hole so patients can convey and remove answers with respect to their ailments utilizing human language. The Wellbeing Bot gives the Chat Bot connection point to removing and recording wellbeing side effects utilizing NLP innovation and by utilizing order calculations to anticipate wellbeing problems.

The Wellbeing Bot is a man-made intelligence programming that can distinguish the aim of the patient's inquiries and lead to the right discussion stream by utilizing regular language insight.

In the view of the forgoing discussion, it is clearly portrayed that there is a need to have an enquiry chat bot and artificial intelligent guidance system and its working method.

### SUMMARY OF THE INVENTION

The present disclosure seeks to provide a system and working method for enquiry chat bot and artificial intelligent guidance. “Enquiry Chat Bot and AI-Guidance using Artificial Intelligent” is the target of the Wellbeing Bot is to investigate and expound on the execution of a clever framework that can uphold telemedicine administrations utilizing normal language handling (NLP) system. Wellbeing Bot is a hearty, modularized, and easy to use stage that intends to work on the patient's collaborations with the medical services framework. Utilizing NLP and discourse acknowledgment calculations, the stage can dissect and arrange free text and voice input information to side effects. The characterized information is utilized in the AI (ML) preparing cycle of the man-made reasoning (computer-based intelligence) models to foresee the likelihood of the patient experiencing a particular illness and get cautioned in the event of problems. The Wellbeing Bot is going about as a clinical virtual specialist to gather any data required in the feeling of a clinical meeting and give clinical evaluations, close meetings with the specialists, and screen/record the patient's ailment. In this Invention, two models have been prepared for the Coronavirus and coronary illness cases with 98.93% and 82.9% exactness, separately. Behind the scenes, thoroughly prepared ML models and calculations are rushing to give the determination involving two models for the Coronavirus and coronary illness cases with 98.93% and 82.9% precision, separately. It is fundamental to comprehend that by digitizing the wellbeing area and involving the patient's information for simulated intelligence purposes, all the more impressive prescient ML models will be created and more illnesses will be distinguished and forestalled on time by breaking down the patient's side effects. Consequently, Clinics ought to share their information in an anonymized and secure way and help outsider stages, like the Wellbeing Bot, to broaden their usefulness and further develop the wellbeing area.

In an embodiment, an enquiry chat bot and artificial intelligent guidance system is disclosed. The system includes a receiving connector for receiving one or both of a voice message and an instant message from a client through a user computing device. The system further includes an informing voice connector for switching discourse over completely to message. The system further includes a normal language parser for separating the words into characterized watchwords. The system further includes a conversational machine learning motor for attempting to bring the right exchange as indicated by the divided catchphrases that lead to the right expectation. The system further includes a Chat Bot for breaking down the client's solicitation to find the purposes and concentrate the elements.

In another embodiment, an enquiry chat bot and artificial intelligent guidance system is disclosed. The method includes receiving one or both of a voice message and an instant message by a receiving connector from a client through a user computing device. The method further includes switching discourse over completely to message by an informing voice connector. The method further includes separating the words into characterized watchwords through a normal language parser. The method further includes attempting to bring the right exchange as indicated by the divided catchphrases that lead to the right expectation using a conversational machine learning motor. The method further includes breaking down the client's solicitation by a Chat Bot to find the purposes and concentrate the elements.

An object of the present disclosure is to investigate and expound on the execution of a clever framework that can uphold telemedicine administrations utilizing normal language handling (NLP) system.

Another object of the present disclosure is to provide a Wellbeing Bot to work on the patient's collaborations with the medical services framework.

Another object of the present disclosure is to provide a characterized information to foresee the likelihood of the patient experiencing a particular illness and get cautioned in the vent of problems.

Another object of the present disclosure is to provide two models have been prepared for the Coronavirus and coronary illness cases with 98.93% and 82.9% exactness, separately.

Another object of the present disclosure is to provide a fundamental to comprehend that by digitizing the wellbeing area and involving the patient's information for simulated intelligence purposes.

Yet another object of the present invention is to deliver an expeditious and cost-effective an enquiry chat bot and artificial intelligent guidance system and working method.

To further clarify advantages and features of the present disclosure, a more particular description of the invention will be rendered by reference to specific embodiments thereof, which is illustrated in the appended drawings. It is appreciated that these drawings depict only typical embodiments of the invention and are therefore not to be considered limiting of its scope. The invention will be described and explained with additional specificity and detail with the accompanying drawings.

### BRIEF DESCRIPTION OF FIGURES

These and other features, aspects, and advantages of the present disclosure will become better understood when the following detailed description is read with reference to the accompanying drawings in which like characters represent like parts throughout the drawings, wherein:

FIG. 1 illustrates a block diagram of an enquiry chat bot and artificial intelligent guidance system in accordance with an embodiment of the present disclosure; and

FIG. 2 illustrates a working method of an enquiry chat bot and artificial intelligent guidance system in accordance with an embodiment of the present disclosure.

Further, skilled artisans will appreciate that elements in the drawings are illustrated for simplicity and may not have necessarily been drawn to scale. For example, the flow charts illustrate the method in terms of the most prominent steps involved to help to improve understanding of aspects of the present disclosure. Furthermore, in terms of the construction of the device, one or more components of the device may have been represented in the drawings by conventional symbols, and the drawings may show only those specific details that are pertinent to understanding the embodiments of the present disclosure so as not to obscure the drawings with details that will be readily apparent to those of ordinary skill in the art having benefit of the description herein.

### DETAILED DESCRIPTION

For the purpose of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

It will be understood by those skilled in the art that the foregoing general description and the following detailed description are exemplary and explanatory of the invention and are not intended to be restrictive thereof.

Reference throughout this specification to “an aspect”, “another aspect” or similar language means that a particular feature, structure, or characteristic described in connection with the embodiment is included in at least one embodiment of the present disclosure. Thus, appearances of the phrase “in an embodiment”, “in another embodiment” and similar language throughout this specification may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

Unless otherwise defined, all technical and scientific terms used herein have the same meaning as commonly understood by one of ordinary skill in the art to which this invention belongs. The system, methods, and examples provided herein are illustrative only and not intended to be limiting.

Embodiments of the present disclosure will be described below in detail with reference to the accompanying drawings.

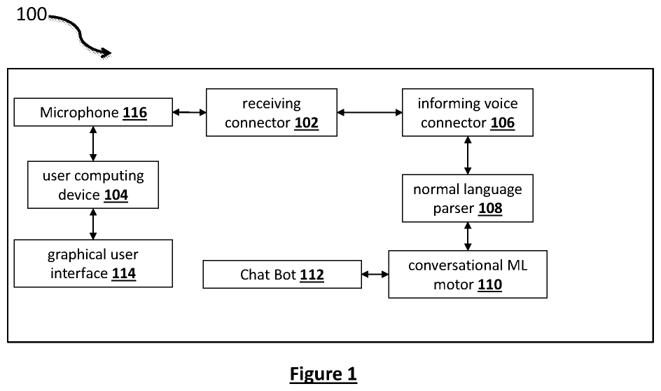

Referring to FIG. 1, a block diagram of an enquiry chat bot and artificial intelligent guidance system is illustrated in accordance with an embodiment of the present disclosure. The system 100 includes a receiving connector 102 for receiving one or both of a voice message and an instant message from a client through a user computing device 104.

In an embodiment, an informing voice connector 106 is used for switching discourse over completely to message.

In an embodiment, a normal language parser 108 is used for separating the words into characterized watchwords.

In an embodiment, a conversational machine learning motor 110 for attempting to bring the right exchange as indicated by the divided catchphrases that lead to the right expectation.

In an embodiment, a Chat Bot 112 is used for breaking down the client's solicitation to find the purposes and concentrate the elements.

In another embodiment, the conversational ML motor, either has a predefined reaction to serve through the reaction motor or performs outer solicitations to webhooks to recover the reaction after the utilitarian handling.

In another embodiment, a graphical user interface 114 installed on the user computing device 104 for uploading voice message and instant message, wherein the voice message is recorded by a microphone 116 coupled to the user computing device 104.

In another embodiment, a patient is allowed to book a meeting with the specialist utilizing a Chat Bot 112 remote helper and have an internet-based connection with the clinic organizations and the wellbeing specialists.

In another embodiment, the Chat Bot 112 is executed to give an alternate point of view in the ongoing manner that medical services interviews, side effect assortment, and determination occur, wherein the Chat Bot 112 gives an instinctive web and application interface that assists the patients with effectively associating with the stage.

In another embodiment, the patients are empowered to utilize human language to speak with the stage which makes the interaction seriously captivating and easy to understand, which is accomplished by the thoroughly prepared NLP specialist, or at least, dealing with the free text arrangement and the stream exchange process.

In another embodiment, the Chat Bot 112 is shared through APIs to allow other outsider stages to associate any suitable wellbeing information source by means of APIs and IoT information stream to advance the patient's verifiable information and further develop the calculations exactness and scoring.

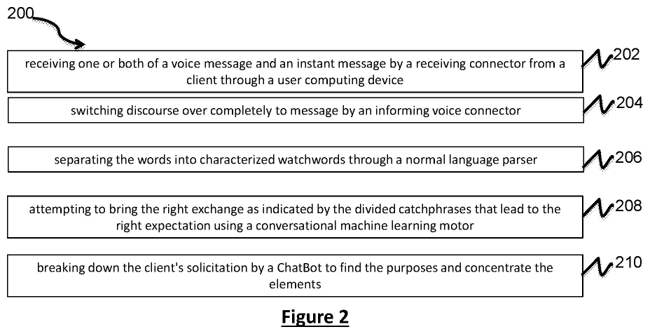

FIG. 2 illustrates a working method of an enquiry chat bot 112 and artificial intelligent guidance system in accordance with an embodiment of the present disclosure. At step 202, the method 200 includes receiving one or both of a voice message and an instant message by a receiving connector 102 from a client through a user computing device 104.

At step 204, the method 200 includes switching discourse over completely to message by an informing voice connector 106.

At step 206, the method 200 includes separating the words into characterized watchwords through a normal language parser 108.

At step 208, the method 200 includes attempting to bring the right exchange as indicated by the divided catchphrases that lead to the right expectation using a conversational machine learning motor 110.

At step 210, the method 200 includes breaking down the client's solicitation by a Chat Bot 112 to find the purposes and concentrate the elements.

In another embodiment, sending a meeting confirmation message with timing to registered email, mobile number, and the inbox of the graphical user interface 114, wherein the patient books a meeting with the specialist on the graphical user interface 114 utilizing a ChatBot remote helper and have an internet-based connection with the clinic organizations and the wellbeing specialists.

In another embodiment, the ChatBot gathers any data required in the feeling of a clinical meeting and give clinical evaluations, close meetings with the specialists, and screen/record the patient's ailment, wherein a camera coupled to the user computing device 104 records the real time patients video while meeting.

In an embodiment, the enquiry chat bot 112 and AI-guidance using artificial intelligent flow in accordance with an embodiment of the present disclosure is provided. The principal parts are likewise portrayed in FIG. 3 work process and are given as follows: (a) the web or application interface to recover the info information, (b) the NLP calculations to examine and section the grouping of words or discourse, (c) the characterization of the logical implications to elements that lead to the stream determination (purposes), and (d) the reaction (text or sound).

Breaking down additional the work process, versatile clients are sending a voice or instant message to the separate connector. The informing voice connector 106 is switching discourse over completely to message for additional handling utilizing the normal language parser 108.

The words are separated into characterized watchwords by means of the normal language parser 108. A short time later, the conversational motor is attempting to bring the right exchange as indicated by the divided catchphrases that lead to the right expectation. Client's solicitation is broken down by the Chat Bot 112 to find the purposes and concentrate the elements.

This cycle is the crucial essential in the Chat Bot's 112 bit. The conversational ML motor, either has a predefined reaction to serve through the reaction motor or performs outer solicitations to Webhooks to recover the reaction after the utilitarian handling. The reaction motor is capable to serve the result to the client's gadget.

The Wellbeing Bot stage is a measured framework that works with the telemedicine Chat Bot 112 biological system prerequisites. The target of the stage is to empower the patients to cooperate with the framework in human language configuration and concentrate important data in regards to their ailments. Additionally, to anticipate the likelihood of experiencing explicit infections as indicated by the gave side effects. Moreover, the patient can book a meeting with the specialist utilizing the Wellbeing Bot remote helper and have an internet-based connection with the clinic organizations and the wellbeing specialists.

The Wellbeing Bot has been executed to give an alternate point of view in the ongoing manner that medical services interviews, side effect assortment, and determination occur. The Wellbeing Bot gives an instinctive web and application interface that assists the patients with effectively associating with the stage.

Patients are empowered to utilize human language to speak with the stage which makes the interaction seriously captivating and easy to understand. This is accomplished by the thoroughly prepared NLP specialist, or at least, dealing with the free text arrangement and the stream exchange process. The Wellbeing Bot modules can be shared through APIs with the goal that other outsider stages can utilize them.

The system will zero in on preparing the NLP calculations in additional dialects and vocabularies. This will help the patient's insight of utilizing the stage and further develop the exchange association.

An extra improvement for the stage is to associate any suitable wellbeing information source by means of APIs and IoT information stream to advance the patient's verifiable information and further develop the calculations exactness and scoring.

“Enquiry Chat Bot 112 and AI-Guidance using Artificial Intelligent” is the target of the Wellbeing Bot is to investigate and expound on the execution of a clever framework that is uphold telemedicine administrations utilizing normal language handling (NLP) innovation. Wellbeing Bot is a hearty, modularized, and easy to use stage that intends to work on the patient's collaborations with the medical services framework. Utilizing NLP and discourse acknowledgment calculations, the stage is dissected and arrange free text and voice input information to side effects. The characterized information is utilized in the AI (ML) preparing cycle of the man-made reasoning (computer-based intelligence) models to foresee the likelihood of the patient experiencing a particular illness and get cautioned in the event of problems. The Wellbeing Bot is going about as a clinical virtual specialist to gather any data required in the feeling of a clinical meeting and give clinical evaluations, close meetings with the specialists, and screen/record the patient's ailment. In the system, two models have been prepared for the Coronavirus and coronary illness cases with 98.93% and 82.9% exactness, separately. Behind the scenes, thoroughly prepared ML models and calculations are rushing to give the determination involving two models for the Coronavirus and coronary illness cases with 98.93% and 82.9% precision, separately. It is fundamental to comprehend that by digitizing the wellbeing area and involving the patient's information for simulated intelligence purposes, all the more impressive prescient ML models will be created and more illnesses will be distinguished and forestalled on time by breaking down the patient's side effects. Consequently, Clinics ought to share their information in an anonymized and secure way and help outsider stages, like the Wellbeing Bot, to broaden their usefulness and further develop the wellbeing area.

“Enquiry Chat Bot 112 and AI-Guidance using Artificial Intelligent” is the target of the Wellbeing Bot is to investigate and expound on the execution of a clever framework that can uphold telemedicine administrations utilizing normal language handling (NLP) innovation.

A Wellbeing Bot is a hearty, modularized, and easy to use stage that intends to work on the patient's collaborations with the medical services framework. Utilizing NLP and discourse acknowledgment calculations, the stage can dissect and arrange free text and voice input information to side effects.

A characterized information is utilized in the AI (ML) preparing cycle of the man-made reasoning (computer-based intelligence) models to foresee the likelihood of the patient experiencing a particular illness and get cautioned in the vent of problems.

A Wellbeing Bot is going about as a clinical virtual specialist to gather any data required in the feeling of a clinical meeting and give clinical evaluations, close meetings with the specialists, and screen/record the patient's ailment.

Two models have been prepared for the Coronavirus and coronary illness cases with 98.93% and 82.9% exactness, separately. Behind the scenes, thoroughly prepared ML models and calculations are rushing to give the determination involving two models for the Coronavirus and coronary illness cases with 98.93% and 82.9% precision, separately.

A fundamental to comprehend that by digitizing the wellbeing area and involving the patient's information for simulated intelligence purposes, all the more impressive prescient ML models will be created and more illnesses will be distinguished and forestalled on time by breaking down the patient's side effects.

A Consequently, Clinics ought to share their information in an anonymized and secure way and help outsider stages, like the Wellbeing Bot, to broaden their usefulness and further develop the wellbeing area.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

1. An enquiry chat bot and artificial intelligent guidance system, the system comprises:
a receiving connector for receiving one or both of a voice message and an instant message from a client through a user computing device;
an informing voice connector for switching discourse over completely to message;
a normal language parser for separating the words into characterized watchwords;
a conversational machine learning motor for attempting to bring the right exchange as indicated by the divided catchphrases that lead to the right expectation; and
a ChatBot for breaking down the client's solicitation to find the purposes and concentrate the elements.

2. The system as claimed in claim 1, wherein the conversational ML motor, either has a predefined reaction to serve through the reaction motor or performs outer solicitations to webhooks to recover the reaction after the utilitarian handling.

3. The system as claimed in claim 1, further comprises a graphical user interface installed on the user computing device for uploading voice message and instant message, wherein the voice message is recorded by a microphone coupled to the user computing device.

4. The system as claimed in claim 1, wherein a patient is allowed to book a meeting with the specialist utilizing a ChatBot remote helper and have an internet-based connection with the clinic organizations and the wellbeing specialists.

5. The system as claimed in claim 1, wherein the ChatBot is executed to give an alternate point of view in the ongoing manner that medical services interviews, side effect assortment, and determination occur, wherein the ChatBot gives an instinctive web and application interface that assists the patients with effectively associating with the stage.

6. The system as claimed in claim 1, wherein the patients are empowered to utilize human language to speak with the stage which makes the interaction seriously captivating and easy to understand, which is accomplished by the thoroughly prepared NLP specialist, or at least, dealing with the free text arrangement and the stream exchange process.

7. The system as claimed in claim 1, wherein the ChatBot is shared through APIs to allow other outsider stages to associate any suitable wellbeing information source by means of APIs and IoT information stream to advance the patient's verifiable information and further develop the calculations exactness and scoring.

8. A working method of an enquiry chat bot and artificial intelligent guidance system, the method comprises:
receiving one or both of a voice message and an instant message by a receiving connector from a client through a user computing device;
switching discourse over completely to message by an informing voice connector;
separating the words into characterized watchwords through a normal language parser;
attempting to bring the right exchange as indicated by the divided catchphrases that lead to the right expectation using a conversational machine learning motor; and
breaking down the client's solicitation by a ChatBot to find the purposes and concentrate the elements.

9. The method as claimed in claim 8, further comprises sending a meeting confirmation message with timing to registered email, mobile number, and the inbox of the graphical user interface, wherein the patient books a meeting with the specialist on the graphical user interface utilizing a ChatBot remote helper and have an internet-based connection with the clinic organizations and the wellbeing specialists.

10. The method as claimed in claim 8, wherein the ChatBot gathers any data required in the feeling of a clinical meeting and give clinical evaluations, close meetings with the specialists, and screen/record the patient's ailment, wherein a camera coupled to the user computing device records the real time patients video while meeting.
